(19) United States
(12) Patent Application Publication
(10) Pub. No.: US 2020/0130362 A1
(43) Pub. Date: Apr. 30, 2020

(54) POROUS BODY, METHOD OF PRODUCING POROUS BODY AND INK JET RECORDING METHOD

(71) Applicant: CANON KABUSHIKI KAISHA, Tokyo (JP)

(72) Inventor: Hiroe Ishikura, Kawasaki-shi (JP)

(21) Appl. No.: 16/662,680

(22) Filed: Oct. 24, 2019

(30) Foreign Application Priority Data
Oct. 31, 2018 (JP) 2018-205400

(51) Int. Cl. B41J 2/185; B41J 13/076

(52) U.S. Cl. CPC B41J 2/185; B41J 13/076

(57) ABSTRACT

A porous body according to the present disclosure has a first porous layer, a second porous layer, and a third porous layer in this order, in which the first porous layer has a fiber constituted by a first fluororesin, the second porous layer has a fiber constituted by a second fluororesin and a thermoset resin, the second fluororesin is the same as the first fluororesin, and the third porous layer has a fiber constituted by a resin having surface energy higher than that of the first fluororesin.

### BACKGROUND OF THE INVENTION

### Field of the Invention

The present disclosure relates to a porous body, a method of producing a porous body and an ink jet recording method.

### Description of the Related Art

In an ink jet recording method, an image (ink image) is formed by applying an ink containing a coloring material onto a recording medium such as paper. At this time, the recording medium absorbs a liquid component in the ink excessively to cause curling or cockling.

Therefore, in order to quickly remove the liquid component in the ink, a method of drying a recording medium is dried by using infrared rays or the like and a method of drying a liquid component contained in an ink image formed on a transfer body by heat energy or the like and then transferring the ink image to a recording medium such as paper are known.

Further, as a method of removing the liquid component contained in the image on the transfer body, a method of absorbing and removing a liquid component from an ink image by using a porous body and bringing the porous body into contact with the ink image instead of heat energy is proposed (Japanese Patent Application Laid-Open No. 2009-45851 and Japanese Patent Application Laid-Open No. 2001-179959).

### SUMMARY OF THE INVENTION

An object of the present disclosure is to provide a porous body capable of, while improving adhesion between layers of the porous body having a plurality of porous layers, sufficiently removing a liquid component from an ink image and suppressing an image defect and a method of producing the porous body. Another object of the present disclosure is to provide an ink jet recording method using the porous body.

According to an aspect of the present disclosure, there is provided a porous body that removes at least a part of a liquid component from an ink image by contact with the ink image containing the liquid component, the ink image being formed by applying ink to an ink receiving medium, the porous body including, in order:

a first porous layer;

a second porous layer; and

a third porous layer,

in which the first porous layer has a surface in contact with the ink image,

the first porous layer and the second porous layer are bonded to each other,

the second porous layer and the third porous layer are bonded to each other,

the first porous layer has a fiber constituted by a first fluororesin,

the second porous layer has a fiber constituted by a second fluororesin and a thermoset resin, and the second fluororesin is the same as the first fluororesin, and

the third porous layer has a fiber constituted by a resin having surface energy higher than that of the first fluororesin.

According to another aspect of the present disclosure, there is provided a method of producing a porous body that removes at least a part of a liquid component from an ink image by contact with the ink image containing the liquid component, the ink image being formed by applying ink to an ink receiving medium, the method including:

preparing a third layer;

forming a second layer having a fiber constituted by a second fluororesin and a thermosetting type adhesive on the third layer;

forming a first layer having a fiber constituted by a first fluororesin on the second layer to obtain a laminate having the first layer, the second layer and the third layer; and

bonding the first layer and the second layer and bonding the second layer and the third layer by heating the laminate to obtain a porous body,

in which the second fluororesin is the same as the first fluororesin, and

the third layer has a fiber constituted by a resin having surface energy higher than that of the first fluororesin.

According to still another aspect of the present disclosure, there is provided an ink jet recording method including: forming an ink image containing a liquid component on an ink receiving medium by applying ink to the ink receiving medium; and

removing at least a part of the liquid component from the ink image by bringing a porous body into contact with the ink image,

in which the porous body has a first porous layer, a second porous layer and a third porous layer in this order,

the first porous layer has a surface in contact with the ink image,

the first porous layer and the second porous layer are bonded to each other,

the second porous layer and the third porous layer are bonded to each other,

the first porous layer has a fiber constituted by a first fluororesin,

the second porous layer has a fiber constituted by a second fluororesin and a thermoset resin, and the second fluororesin is the same as the first fluororesin, and

the third porous layer has a fiber constituted by a resin having surface energy higher than that of the first fluororesin.

Further features of the present disclosure will become apparent from the following description of exemplary embodiments with reference to the attached drawings.

### BRIEF DESCRIPTION OF THE DRAWINGS

FIG. 1 is a schematic diagram illustrating an outline of a configuration of an electrospinning apparatus according to an embodiment of the present disclosure.

FIG. 2 is a schematic diagram illustrating an example of a configuration of a transfer type ink jet recording apparatus used in a transfer type ink jet recording method according to an embodiment of the present disclosure.

FIG. 3 is a schematic diagram illustrating an example of a configuration of a direct drawing type ink jet recording apparatus used in a direct drawing type ink jet recording method according to an embodiment of the present disclosure.

### DESCRIPTION OF THE EMBODIMENTS

Since a roller-shaped porous body is used as the porous body described in Japanese Patent Application Laid-Open No. 2009-45851, the amount of the liquid component that can be removed is limited, and the configuration of an ink jet recording apparatus is complicated when there is an attempt to further speed up an image recording process. From this viewpoint, it has been found that the porous body is not sufficient. In addition, in a case where the polymer absorber described in Japanese Patent Application Laid-Open No. 2001-179959 is brought into contact with an ink image and the liquid component is removed from the ink image, the liquid component may not be sufficiently removed from the ink image. Thus, it has been found that further improvement is required.

Although the porous body is not a porous body that removes a liquid component from an ink image, as a film for filtering impurities such as dust in gas, liquid and the like, a porous body obtained by laminating a porous body having high collection efficiency has been investigated. However, according to the investigation by the present inventors, it has been found that even when such a porous body is used to remove a liquid component from an ink image, a sufficient function cannot be exhibited.

For example, in Japanese Patent Application Laid-Open No. 2013-71456, a porous sheet used in a lamination type ceramic capacitor peeling process is proposed. In the invention described in Japanese Patent Application Laid-Open No. 2013-71456, by bonding a fine fiber web layer to one surface or both surfaces of a porous support layer, the strength and thickness sufficient for use in the lamination type ceramic capacitor peeling laminating process can be obtained. However, when the porous sheet is brought into contact with the ink image and the liquid component is removed from the ink image, the fine web layer mixed with an adhesive is brought into contact with a recording medium. By bringing this adhesive into contact with the recording medium, the peelability of the porous body from the recording medium after the liquid component is removed cannot be sufficiently ensured, and desired characteristics may not be obtained.

In Japanese Patent Application Laid-Open No. 2017-101346, a laminated nonwoven fabric capable of ensuring a high adhesive strength between nonwoven fabrics is proposed. In the invention described in Japanese Patent Application Laid-Open No. 2017-101346, the adhesive strength between the nonwoven fabrics using the adhesive is ensured by an uneven shape by the anchor effect. Therefore, in a case where this laminated nonwoven fabric is brought into contact with the ink image in order to remove the liquid component from the ink image, the influence on the image by this uneven shape is assumed, and thus the laminated nonwoven fabric cannot be used.

Hereinafter, exemplary embodiments of the present disclosure will be described in detail with reference to a preferred embodiment. For convenience, each layer forming a laminate before a heat treatment in preparing a porous body may be referred to as “first layer”, “second layer”, and “third layer”. Here, the first layer, the second layer, and the third layer are subjected to a heat treatment to form a first porous layer, a second porous layer, and a third porous layer, respectively. In addition, the first layer, the second layer, and the third layer are all porous layers similar to the first porous layer, the second porous layer, and the third porous layer. The thermoset resin included in the second porous layer of the porous body is cured by heating the thermosetting type adhesive included in the second layer.

The porous body according to the present disclosure is a porous body that removes at least a part of the liquid component from the ink image by contact with an ink image containing a liquid component, the ink image being formed by applying ink to an ink receiving medium.

This porous body has a first porous layer, a second porous layer, and a third porous layer in this order. The first porous layer has a surface in contact with the ink image. The first porous layer and the second porous layer are bonded to each other and the second porous layer and the third porous layer are bonded to each other. Specifically, a surface of the first porous layer opposite to the surface in contact with the ink image and one surface of the second porous layer are bonded to each other. Further, the other surface of the second porous layer (that is, a surface opposite to the surface in contact with the first porous layer) and one surface of the third porous layer are bonded to each other.

The first porous layer has a fiber constituted by a first fluororesin. Since the fluororesin has low surface energy, while a coloring material and a resin in the ink image cannot be easily incorporated, the adhesion with the second porous layer may not be sufficient. With respect to such a problem, in the present disclosure, the second porous layer has a fiber containing a second fluororesin that is the same as the first fluororesin. By bonding the first fluororesin and the second fluororesin, the adhesion between the first porous layer and the second porous layer can be improved.

Further, the fiber of the second porous layer constituted by a second fluororesin and a thermoset resin derived from a thermosetting type adhesive. Since the third porous layer has a fiber constituted by a resin having surface energy higher than that of the first fluororesin, the third porous layer is firmly bonded by the thermoset resin than the first porous layer. Therefore, by the thermoset resin, adhesion between the second porous layer and the third porous layer can be improved. In addition, by incorporating a thermoset resin into the second porous layer present between the first porous layer and the third porous layer, the thermoset resin is not easily exposed to the surface of the porous body and thus the influence of the thermoset resin on other members to be brought into contact with the porous body on the image can be suppressed.

The configuration of each porous layer will be described later.

[Method of Producing Porous Body]

A method of producing a porous body has (i) a process of preparing a third layer, (ii) a process of forming a second layer on the third layer, (iii) a process of forming the first layer on the second layer to obtain a laminate, and (iv) a process of heating the laminate to obtain a porous body.

The second layer has a fiber constituted by a second fluororesin and a thermosetting type adhesive. The third layer has a fiber constituted by a resin having surface energy higher than that of the first fluororesin. In a state where the second layer is brought into contact with the third layer, the thermosetting type adhesive is turned into a thermoset resin by heating the thermosetting type adhesive to a curable temperature or higher, and the second porous layer and the third porous layer are bonded by this thermoset resin.

In addition, the fiber containing a thermosetting type adhesive included in the second layer also contains a second fluororesin which is the same as the first fluororesin included in the first layer. Although the reason why adhesion between the first porous layer and the second porous layer is improved by using the same fluororesin as the first fluororesin and the second fluororesin is unknown, the present inventors assume that this is affinity between the fluororesins. That is, it is assumed that when the first fluororesin and the second fluororesin are softened, the fluororesins with high affinity are bonded to each other and thus adhesion between the first porous layer and the second porous layer are improved.

In addition, the porous body is preferably formed using an electrospinning method. Specifically, using an electrospinning method, the fibers forming the first layer, the second layer, and the third layer that become the first porous layer, the second porous layer, and the third porous layer can be formed. Particularly, the fiber constituted by the second fluororesin and the thermosetting type adhesive forming the second porous layer can be obtained by adding a fluororesin and a thermosetting type adhesive in a resin solution in a fiber forming process. Each process for producing the porous body of the present disclosure will be described below.

(Fiber Forming Process)

The porous body of the present disclosure is preferably obtained by laminating porous layers including three or more fiber layers containing a resin.

The resin forming the first layer, the second layer, the first porous layer and the second porous layer is not particularly limited as long as the resin is a fluororesin, and examples thereof include polytetrafluoroethylene (PTFE), polychlorotrifluoroethylene (PCTFE), polyvinylidene fluoride (PVDF), polyvinyl fluoride (PVF), perfluoroalkoxy resin (PFA), tetrafluoroethylene-hexafluoropropylene copolymer (FEP), ethylene-tetrafluoroethylene copolymer (ETFE), ethylene-chlorotrifluoroethylene copolymer (ECTFE), poly(vinylidene fluoride-co-hexafluoropropylene) (PVDF-HFP), and tetrafluoroethylene-hexafluoropropylene-vinylidene fluoride copolymer (PTFE-HFP-VDF). These resins may be used alone or two or more thereof as necessary. Moreover, it is preferable to fiberize the resin using a resin solution by an electrospinning method. Therefore, the fluororesin is preferably soluble in an organic solvent. That is, the first fluororesin and the second fluororesin are preferably soluble in an organic solvent.

Next, the second layer has a fiber constituted by a second fluororesin which is the same as the first fluororesin included in the first layer and a thermosetting type adhesive. The second porous layer has a fiber constituted by the second fluororesin which is the same as the first fluororesin included in the first porous layer and a thermoset resin formed by heating the thermosetting type adhesive. The thermosetting type adhesive is not particularly limited and instead of a thermosetting type adhesive that cures at room temperature for a long time, a thermosetting type adhesive of which the curing reaction proceeds in a short time by heating is preferable. Specifically, it is preferably an adhesive that can be cured at 50° C. or higher to 150° C. or lower, that is, an adhesive having a curing reaction start temperature of 50° C. or higher to 150° C. or lower. As the kind of the adhesive, for example, epoxy, silicone, acrylic, and urethane adhesives can be used. Among these, from the viewpoint of compatibility with the resin solution, the thermosetting type adhesive is preferably an epoxy adhesive. In addition, thermosetting type adhesives other than those exemplified above can also be used. Further, the adhesive can be dissolved in an organic solvent together with the fluororesin, and at the same time, fiberization is preferably performed by an electrospinning method. Therefore, it is preferable that the thermosetting type adhesive is soluble in an organic solvent.

Further, the third layer and the third porous layer have a fiber constituted by a resin having surface energy higher than that of the first fluororesin. The resin forming the third layer can be bonded to the thermosetting type adhesive included in the second layer, and as long as a predetermined adhesive strength with respect to the third porous layer can be ensured by a thermoset resin formed by heating the thermosetting type adhesive, the resin is not particularly limited. As the resin forming the third layer and the third porous layer, for example, polyacrylonitrile (PAN), polycarbonate, polyethylene, polypropylene, polyethylene oxide, polyethylene glycol, polyethylene terephthalate, polyethylene naphthalate, poly-m-phenylene terephthalate, poly-p-phenylene isophthalate, polymethacrylic acid, polymethyl methacrylate, poly vinyl chloride, polyvinylidene chloride-acrylate copolymer, polyvinyl alcohol, polyvinyl pyrrolidone, polyarylate, polyacetal, polycarbonate, polystyrene, polysulfone, polyethersulfone, polyphenylsulfone, polyphenylene sulfide, polyamide, polyimide, polyamideimide, aramid, polyimide benzazole, polybenzimidazole, polyglycolic acid, polylactic acid, polyurethane, cellulose compounds, polypeptide, polynucleoside, proteins, and enzymes. Resins other than the resins exemplified above can also be used. Among these, polysulfone can be suitably used as a resin having an appropriate strength and good adhesion to the adhesive.

In the above description, although the electrospinning method is mentioned as a method for forming a fiber, it is not necessarily limited to the fiber formed by this method. For example, a known method such as a melt blow method can be used. However, particularly, for the first porous layer and the second porous layer, the electrospinning method capable of forming a particularly fine fiber is preferable. This is because that a porous layer constituted by a fine fiber (that is, a fiber having a small fiber diameter) can be formed and when the porous body is brought into contact with an ink image, while a pigment and resin particles are not easily incorporated, the porous layer can absorb a liquid component. The electrospinning method includes a solution type and a melt type, but a solution type electrospinning method capable of forming a finer fiber is more preferable.

A spinning method based on the solution type electrospinning method is a technique in which a positive high voltage is applied to a polymer solution and fiberization is caused in a process of spraying the solution on a grounded or negatively charged surface. The solution is ejected from a nozzle having a small diameter. Generally, as the nozzle diameter becomes smaller, the fiber diameter to be formed becomes smaller.

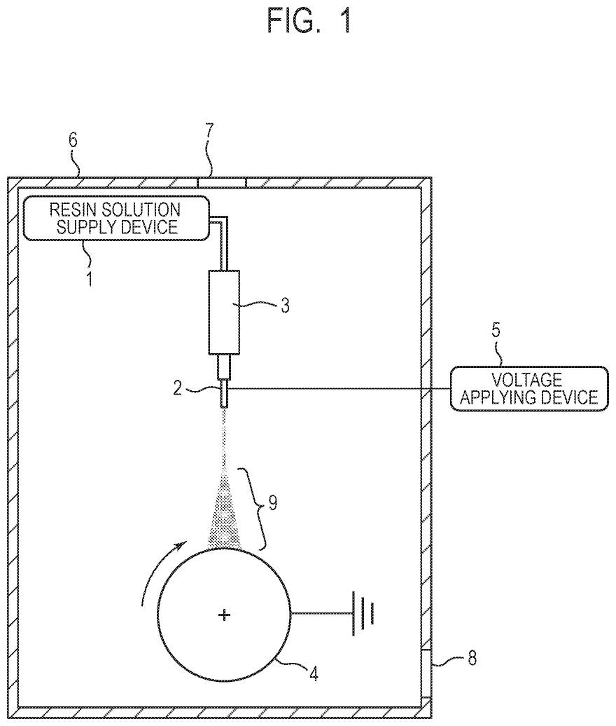

An electrospinning apparatus shown in FIG. 1 includes a resin solution supply device 1 that can supply a resin solution 3 to a nozzle 2, and a grounded collector 4 that can collect a fiber 9 ejected from the nozzle 2 and stretched by an electric field. Further, the electrospinning apparatus includes a voltage applying device 5 that can apply a voltage to the nozzle 2 to form an electric field between the nozzle 2 and the grounded collector 4. Further, a spinning space is surrounded by a spinning container 6, and the spinning container 6 includes an intake port 7 and an exhaust port 8 for exhausting the evaporated solvent. An air conditioner (not shown) may be attached to the intake port 7 to adjust the temperature and humidity inside the spinning container 6.

In a case where the fiber 9 is formed using such an electrospinning apparatus, first, the resin solution 3 is prepared. This resin solution 3 is a solution in which a resin that can be spun by the electrospinning method is dissolved in a solvent.

The weight average molecular weight of the resin is preferably 10,000 or more to 1,000,000 or less and more preferably 100,000 or more to 500,000 or less. When the weight average molecular weight of the resin is within the above range, the resin is easily fiberized by the electrospinning apparatus.

The resin is preferably completely dissolved in the solvent.

The solvent included in the resin solution 3 may be any solvent that can dissolve the resin and is not particularly limited. Examples thereof include water, acetone, methyl isobutyl ketone, diisobutyl ketone, acetophenone, ethyl acetate, butyl acetate, methanol, ethanol, propanol, isopropanol, hexafluoroisopropanol, tetrahydrofuran, dimethyl sulfoxide, 1,4-dioxane, pyridine, N,N-dimethylformamide, N,N-dimethylacetamide, N-methyl-2-pyrrolidone, acetonitrile, formic acid, toluene, benzene, cyclohexane, cyclohexanone, carbon tetrachloride, methylene chloride, chloroform, trichloroethane, ethylene carbonate, diethylene carbonate and propylene carbonate. These solvents may be used alone or as a mixture.

Furthermore, a salt such as lithium chloride, lithium bromide or sodium chloride, a surfactant, and the like may be added to the resin solution 3 as additives.

(Fiber Layer (First Layer, Second Layer and Third Layer) Lamination Process)

The porous body according to the present disclosure has a function of absorbing the liquid component in the ink image by bringing the porous body into contact with the ink applied to the ink receiving medium. Therefore, it is preferable that the average pore diameter of the porous body is small on the surface in contact with the ink image, and the structure has a high porosity and good liquid permeability so that only the liquid component is absorbed and the inside of the porous body can sufficiently hold and remove the liquid component. Therefore, it is preferable that a structure in which in the first layer and the second layer, the average pore diameter is reduced by thinning the fiber (decreasing the fiber diameter), the fiber of the third layer is thicker than the fibers forming the first layer and the second layer (increasing the fiber diameter), and the average pore diameter is large is preferable.

In the preparation of the porous body, first, the third layer is prepared. Examples of the third layer include a support layer for securing strength. Although the production method of the third layer is not particularly limited, the surface energy and softening point of the material are preferably higher than those of the first layer. Further, the adhesive strength (tensile strength) after curing of the thermosetting type adhesive included in the second layer and the resin included in the third layer, that is, the adhesive strength (tensile strength) between the second porous layer and the third porous layer is preferably 800 g/cm² or more. In a case where the first layer and the second layer are prepared by an electrospinning method, the third layer is preferably attached to the collector surface of electrospinning, and the second layer and the first layer are preferably laminated in this order. At this time, the third layer can be similarly prepared using the electrospinning method. Further, the third layer may have a single layer or a laminated structure including a plurality of layers. In a case where the third layer has a laminated structure, the adhesive strength of each layer is preferably 800 g/cm² or more.

First, the second layer is formed on the third layer. The resin solution 3 used for forming the second layer is a solution obtained by dissolving the above resin in the above solvent. The concentration at that time varies depending on the composition of the resin, the molecular weight of the resin, the solvent and the like, but from the viewpoint of applicability to the electrospinning method, it is preferable to adjust the concentration of the resin to be 1% by mass or more to 50% by mass or less based on the total mass of the resin solution. When the concentration of the resin is less than 1% by mass, the solvent does not evaporate and tends to be not easily fiberized. When the concentration of the resin is more than 50% by mass, the solubility of the resin is lowered and the resin solution 3 is not easily stretched. This is because the solvent tends to be not easily fiberized. Further, a thermosetting type adhesive is added to the resin solution 3. The content of the thermosetting type adhesive is not particularly limited as long as the adhesive strength with the third layer can be ensured during the heat treatment process of the porous body described later. The content of the thermosetting type adhesive in the second layer is preferably 0.1% by mass or more to 30% by mass or less, more preferably 0.5% by mass or more to 10% by mass or less and still more preferably 1% by mass or more to 5% by mass or less based on the total resin content in the second layer. Therefore, in a case where the second layer is prepared by the electrospinning method, the content of the thermosetting type adhesive is preferably 0.1% by mass or more to 30% by mass or less, more preferably 0.5% by mass or more to 10% by mass or less and still more preferably 1% by mass or more to 5% by mass or less based on the resin content in the resin solution 3. The content of the thermoset resin in the second porous layer is preferably 0.1% by mass or more to 30% by mass or less, more preferably 0.5% by mass or more to 10% by mass or less and still more preferably 1% by mass or more to 5% by mass or less based on the total resin content in the second porous layer. In consideration of suitability for the electrospinning method, the added thermosetting type adhesive is preferably soluble in the resin solution 3 forming the second layer. Furthermore, it is preferable that the curing reaction start temperature of the thermosetting type adhesive is lower than the softening point of the second fluororesin. In the present disclosure, the curing reaction start temperature of the thermosetting type adhesive is confirmed by differential scanning calorimetry (DSC).

The fluororesin forming the second layer is the same as the fluororesin forming the first layer that is the outermost surface. The second layer is formed to ensure adhesion with the first layer by the resin and to ensure adhesion with the third layer by the thermosetting type adhesive. The second layer may function only for adhesion between the first layer and the third layer, and the second layer is required not to impair its structure and function. Therefore, the thickness of the second layer is preferably 50 μm or less and more preferably 1 μm or more to 10 μm or less. The thickness of the second porous layer is preferably 50 μm or less and more preferably 1 μm or more to 10 μm or less.

The resin solution 3 is supplied to the nozzle 2 by the resin solution supply device 1. The supplied resin solution 3 is extruded from the nozzle 2, and under a stretching action due to the electric field between the grounded collector 4 and the nozzle 2 applied by the voltage applying device 5, the resin solution is sprayed toward the collector 4 while being fiberized. The sprayed fiber 9 is accumulated on the collector 4 to form a porous film. In addition, although the resin solution supply device 1 is not particularly limited, for example, a syringe pump, a tube pump, a dispenser and the like can be used.

The diameter of the nozzle 2 varies depending on the fiber diameter of the fiber 9 to be obtained, and is not particularly limited. For example, the diameter (inner diameter) is preferably 0.1 mm or more to 2.0 mm or less.

The nozzle 2 may be formed of a metal or non-metallic material. When the nozzle 2 is formed of a metal, the nozzle 2 can be used as one electrode by applying a voltage from the voltage applying device 5. When the nozzle 2 is formed of a non-metallic material, an electrode is installed inside the nozzle 2 or in a supply pipe from the spinning resin solution supply device 1 to the nozzle 2 and a voltage is applied from the voltage applying device 5 to this electrode so that an electric field can be applied to the extruded resin solution 3.

In FIG. 1, a voltage is applied to the nozzle 2 by a voltage applying device 5 and an electric field is formed by grounding the collector 4. In contrast to FIG. 1, the nozzle 2 may be grounded and a voltage may be applied to the collector 4 to form an electric field. Alternately, while being applied to both the nozzle 2 and the collector 4, a voltage may be applied to form an electric field so that a potential difference is provided.

The voltage applying device 5 is not particularly limited, and for example, a DC high voltage generator or a Van de Graf electromotive machine can be used. The applied voltage is not particularly limited, but is preferably 5 kV or more to 50 kV or less.

The collector 4 in FIG. 1 has a drum shape and is not particularly limited as long as the collector 4 has conductivity. Further, in the present disclosure, since the fiber 9 is accumulated in a state where the porous films below the third layer are attached in advance, a conductive material is applied in advance to the third layer or below, or a layer formed of a conductive material may be used. For example, a nonwoven fabric, a woven fabric, a knitted fabric, a net and the like, formed of a conductive material, such as metal or carbon, can be used, but a nonwoven fabric, a woven fabric, a knitted fabric, a net and the like, formed of a non-conductive organic material, can also be used.

Since a distance from the tip end of the nozzle 2 to the collector 4 varies depending on the fiber diameter of the fiber 9 to be obtained and the amount of the residual solvent, for example, the distance is preferably 5 cm or more to 30 cm or less although the distance is not particularly limited.

In the present disclosure, the average fiber diameter of the fiber is preferably 0.1 μm or more to 5.0 μm or less and more preferably 0.1 μm or more to 3 μm or less. The fiber diameter can be measured by SEM observation from the surface or SEM observation after forming a cross section by ion milling, FIB or the like. In the present disclosure, an average value is calculated by measuring the fiber diameters at 20 locations that can be clearly identified by an SEM photograph.

Subsequently, a first layer is formed. The material of the first layer is not limited as long the material is a material that functions as a porous body for bring the material into contact with the ink applied to a recording medium so as to absorb the liquid in the ink, in consideration of the absorption efficiency of only the liquid component, it is important to use a fluororesin. Other than the first layer, since the higher affinity with the liquid component can increase the absorption efficiency, the surface energy of the first layer resin is preferably lower than the surface energy of the third layer resin.

The first layer is continuously spun onto a laminate in which the second layer is spun on the third layer. Regarding the spinning conditions, the above-mentioned second layer is prepared in the same manner.

(Heat Treatment Process)

In this process, a heat treatment is performed on the laminate having the layers (first layer, second layer and third layer) including the fiber formed as described above. The heating temperature may be a temperature at which the first layer and the second layer are bonded and the second layer and the third layer are bonded. In order to bond the first layer and the second layer to each other, the first fluororesin in the first layer and the second fluororesin in the second layer may be set in a bondable state. Therefore, the heating temperature is not necessarily a temperature equal or higher than the softening point of the first fluororesin and the second fluororesin, and even when the heating temperature is lower than the softening point of the first fluororesin and the second fluororesin, the first fluororesin and the second fluororesin may be bonded by a pressurizing treatment described later. However, since a molecular chain constituting the first fluororesin and the second fluororesin is in a state where the molecular chain can move to some extent and is effective in bonding the first fluororesin and the second fluororesin, it is preferable that the heating temperature is preferably at least 25° C. lower than the temperature that is the softening point of the first fluororesin and the second fluororesin. On the other hand, it is preferable that the heating temperature is preferably lower than the softening point of the first fluororesin in the first layer in order to prevent the pores of the first porous layer from being crushed by this heat treatment. Further, in order to bond the second layer and the third layer, it is important that the heating temperature is equal to or higher than the curing reaction start temperature of the thermosetting type adhesive included in the second layer.

Note that a pressurizing treatment is preferably performed during the heat treatment. That is, the heat treatment is preferably a heating and pressurizing treatment. Since the contact area between the fibers is increased by pressurization, bonding is more easily performed. In addition, even when the heating temperature is less than the softening point of the first fluororesin and the second fluororesin, the adhesive force between the first fluororesin and the second fluororesin can be improved by the pressurizing treatment. However, since the fibers are crushed and the voids are reduced to reduce the liquid permeability when the fibers are excessively pressured, the pressure is preferably 10 kg/cm² or less and more preferably 5 kg/cm² or less.

As the heating device, a hot air dryer, an oven, an infrared (IR) heating device, a microwave heating device or the like can be used. In the case of further pressurization, a flat plate press machine, a roll press machine, a laminator, a calendar device and the like with a heating mechanism can be used as appropriate.

In the present disclosure, the softening point is the Vicat softening temperature and is measured by the B50 method of JIS K 7205.

Further, in a case where a plurality of resins are mixed, the softening point of the resin having the largest volume is shown.

In the present disclosure, the surface energy of the resin is measured by a contact angle method. A contact angle meter (DM-701, manufactured by Kyowa Interface Science Co., Ltd.) is used to measure the surface energy of the resin by the contact angle method. Then, the contact angle with respect to the three liquids of water, diiodomethane, and n-hexadecane is measured (23° C., 50% RH), and the surface energy is calculated by the Kitazaki-Hata method.

In the present disclosure, the thickness of each porous layer is measured by observing a cross section of the porous body using a scanning electron microscope (SEM).

[Ink Jet Recording Method]

An ink jet recording method according to the present disclosure includes an ink application process and a liquid component removal process. The ink application process is a process of forming an ink image including a liquid component on an ink receiving medium by applying ink to the ink receiving medium. The liquid component removal process is a process of removing at least a part of the liquid component from the ink image by bringing a porous body into contact with the ink image. The porous body is a porous body having the first porous layer, the second porous layer, and the third porous layer in this order. According to the ink jet recording method according to the present disclosure, the liquid component can be sufficiently removed from the ink image and the image flow can be suppressed, so that a good image can be obtained.

Hereinafter, an ink jet recording apparatus using the ink jet recording method according to an embodiment of the present disclosure will be described with reference to the drawings.

Examples of the ink jet recording apparatus according to the exemplary embodiment, an ink jet recording apparatus that forms an ink image by ejecting an ink onto a transfer body as an ink receiving medium, and transfers the ink image to a recording medium after absorbing liquid from the ink image by a liquid absorbing member, and an ink jet recording apparatus that forms an ink image on a recording medium such as paper or cloth as an ink receiving medium and absorbs liquid from the ink image on the recording medium by a liquid absorbing member. In the present disclosure, the former ink jet recording apparatus is hereinafter referred to as a transfer type ink jet recording apparatus for the sake of convenience, and the latter ink jet recording apparatus is referred to as a direct drawing type ink jet recording apparatus for the sake of convenience.

Each ink jet recording apparatus will be described below.

[Transfer Type Ink Jet Recording Apparatus]

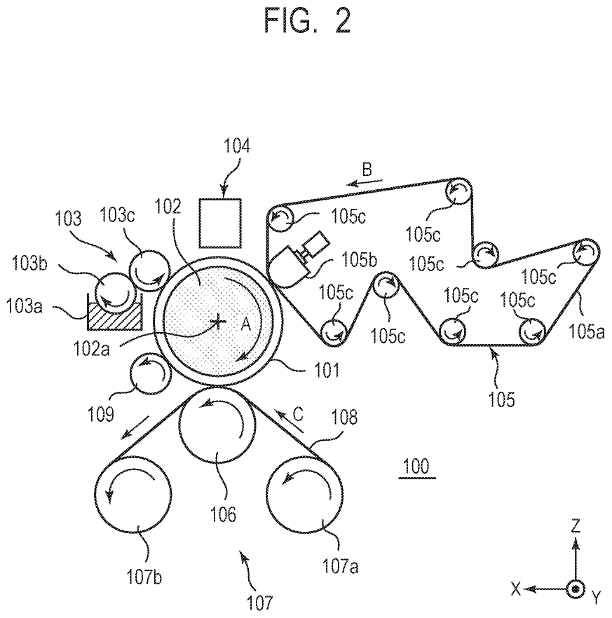

FIG. 2 is a schematic diagram illustrating an example of a schematic configuration of a transfer type ink jet recording apparatus 100 according to the exemplary embodiment. This recording apparatus is a sheet-fed ink jet recording apparatus that produces a recorded material by transferring an ink image onto a recording medium 108 through a transfer body 101. In the exemplary embodiment, an X direction, a Y direction, and a Z direction indicate a width direction (a total length direction), a depth direction, and a height direction of the ink jet recording apparatus 100, respectively. A recording medium 108 is conveyed in the X direction.

As shown in FIG. 2, the transfer type ink jet recording apparatus 100 according to the present disclosure has a transfer body 101 supported by a support member 102, a reaction liquid applying device 103 that applies a reaction liquid that reacts with a color ink on the transfer body 101, an ink applying device 104 that includes an ink jet head that applies a colored ink onto the transfer body 101 to which the reaction liquid is applied, and forms an ink image that is an image of the ink on the transfer body, a liquid absorbing device 105 that absorbs a liquid component from the ink image on the transfer member, and a transfer pressing member 106 for transferring the ink image on the transfer body from which the liquid component is removed onto the recording medium 108 such as paper. Further, the transfer type ink jet recording apparatus 100 may have a transfer body cleaning member 109 that cleans the surface of the transfer body 101 after being transferred, as necessary. As a matter of course, the transfer body 101, the reaction liquid applying device 103, the ink jet head of the ink applying device 104, the liquid absorbing device 105, and the transfer body cleaning member 109 each have a length corresponding to the recording medium 108 used in the Y direction.

The transfer body 101 rotates around a rotation shaft 102a of the support member 102 in the direction of arrow A in FIG. 2. Due to the rotation of the support member 102, the transfer body 101 is moved. On the moving transfer body 101, the reaction liquid is applied by the reaction liquid applying device 103 and the ink is sequentially applied by the ink applying device 104 to form an ink image on the transfer body 101. The ink image formed on the transfer body 101 is moved to a position in contact with the liquid absorbing member 105a included in the liquid absorbing device 105 by the movement of the transfer body 101. The liquid absorbing member 105a has the porous body according to the present disclosure, and the porous body is arranged so as to be in contact with the ink image. The reaction liquid applying device 103 in FIG. 2 indicates a gravure offset roller which has a reaction liquid storing unit 103a that stores a reaction liquid and reaction liquid applying members 103b and 103c that apply the reaction liquid in the reaction liquid storing unit 103a to the transfer body 101.

The transfer body 101 and the liquid absorbing device 105 move in synchronization with the rotation of the transfer body 101. The ink image formed on the transfer body 101 is brought into contact with the moving liquid absorbing member 105a. During this time, the liquid absorbing member 105a removes the liquid component from the ink image on the transfer body. In this contact state, it is particularly preferable that the liquid absorbing member 105a is pressed against the transfer body 101 with a predetermined pressing force from the viewpoint of causing the liquid absorbing member 105a to effectively function. The liquid absorbing member 105 in FIG. 2 has, in addition to liquid absorbing member 105a, a liquid absorbing pressing member 105b that presses the liquid absorbing member 105a against the ink image on the transfer body 101, and a stretching roller 105c as a stretching member for stretching the liquid absorbing member 105a. Then, the liquid absorbing member 105a moves in the direction of arrow B in FIG. 2.

The shapes of the liquid absorbing member 105a and the pressing member 105b are not particularly limited. For example, as shown in FIG. 2, a configuration in which the pressing member 105b has a curved surface, the liquid absorbing member 105a has a belt shape, and the pressing member 105b presses the belt-shaped liquid absorbing member 105a against the transfer body 101 may be adopted. In addition, a configuration in which the pressing member 105b has a cylindrical shape, the liquid absorbing member 105a has a belt shape formed on the peripheral surface of the cylindrical pressing member 105b, and a belt-shaped liquid absorbing member 105a is pressed against the transfer body with the cylindrical pressing member 105b may be adopted.

When the removal of the liquid component is described from a different view point, it can also be expressed as concentrating the ink forming the ink image formed on the transfer body. Concentrating the ink means that as the liquid component contained in the ink decreases, the content ratio with respect to the liquid component of the solid content such as the coloring material and the resin contained in ink increases.

Then, the ink image after liquid removal from which the liquid component is removed is in a state where the ink is concentrated compared to the ink image before the liquid removal, and further, the ink image is moved to a transfer unit that is brought into contact with the recording medium 108 conveyed by a recording medium conveying device 107 by the movement of the transfer body 101. The ink image after liquid removal is transferred onto the recording medium 108 as an ink image by pressing the transfer body 101 with the transfer pressing member 106 while the ink image after liquid removal is in contact with the recording medium 108. The ink image transferred onto the recording medium 108 is an ink image before liquid removal, and a reverse image of the ink image after liquid removal. The recording medium conveying device 107 in FIG. 2 has a recording medium feeding roller 107a and a recording medium winding roller 107b. Then, the recording medium 108 is conveyed in the direction of arrow C by the recording medium conveying device 107.

In this exemplary embodiment, since the reaction liquid is applied to the transfer body and then the ink is applied to form an ink image, in the non-image region where the ink image is not formed, the reaction liquid remains without reacting with the ink. In this apparatus, the liquid absorbing member 105a is brought into contact with not only the ink image but also the unreacted reaction liquid, and removes the liquid component of the reaction liquid as well.

Therefore, the expression that the liquid component is removed from the ink image is described above, but is used in the sense that the liquid component is removed from at least the ink image on the transfer body, not the limited meaning that the liquid component is removed only from the ink image.

The liquid component is not particularly limited as long as the liquid component does not have a certain shape, has fluidity, and has a substantially constant volume.

For example, water, an organic solvent, or the like contained in the ink or the reaction liquid can be mentioned as the liquid component.

For each configuration (the transfer body, the reaction the liquid applying device, the ink applying device, the liquid absorbing device, the transfer pressing member, the recording medium conveying device, and the like) other than the porous body included in the transfer type ink jet recording apparatus according to the exemplary embodiment, known components can be used.

[Direct Drawing Type Ink Jet Recording Apparatus]

As another embodiment of the exemplary embodiment, a direct drawing type ink jet recording apparatus can be mentioned. In the direct drawing type ink jet recording apparatus, the ink receiving medium is a recording medium on which an image is to be formed.

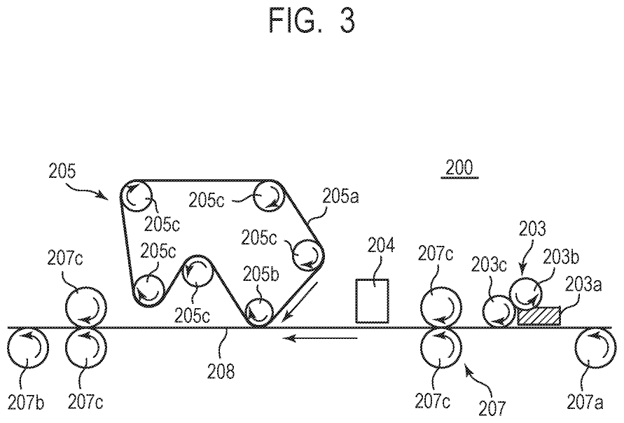

FIG. 3 is a schematic diagram illustrating an example of a schematic configuration of a direct drawing type ink jet recording apparatus 200 in the exemplary embodiment. Compared with the transfer type ink jet recording apparatus described above, the transfer type ink jet recording apparatus has the same units except that the direct drawing type ink jet recording apparatus does not have the transfer body 101, the support member 102 and the transfer body cleaning member 109, and an image is formed on a recording medium 208.

Accordingly, a liquid absorbing device 205 that absorbs a liquid component contained in an ink image by a reaction liquid applying device 203 that applies a reaction liquid to the recording medium 208, an ink applying device 204 that applies an ink to the recording medium 208, and a liquid absorbing member 205a that is brought into contact with an ink image on the recording medium 208 has the same configuration as the transfer type ink jet recording apparatus, and the description thereof is omitted. The reaction liquid applying device 203 in FIG. 3 is a gravure offset roller having a reaction liquid storing unit 203a that stores a reaction liquid, and reaction liquid applying members 203b and 203c that apply the reaction liquid in the reaction liquid storing unit 203a to the recording medium 208.

In the direct drawing type ink jet recording apparatus of the exemplary embodiment, the liquid absorbing device 205 has the liquid absorbing member 205a having the porous body of the exemplary disclosure, and the liquid absorbing pressing member 205b that presses the liquid absorbing member 205a against an ink image on the recording medium 208. The shapes of the liquid absorbing member 205a and the pressing member 205b are not particularly limited, and those having the same shape as the liquid absorbing member and the pressing member that can be used in the transfer type ink jet recording apparatus can be used. Further, the liquid absorbing device 205 may have a stretching member that stretches the liquid absorbing member. In FIG. 3, 205c represents a stretching roller as a stretching member. The number of stretching rollers is not limited to five in FIG. 3, and the necessary number of stretching rollers may be arranged according to the device design. In addition, in an ink applying unit that applies an ink to the recording medium 208 by the ink applying device 204 and a liquid component removing unit that brings the liquid absorbing member 205a into contact with the ink image on the recording medium, a recording medium supporting member (not shown) that supports the recording medium from below may be provided.

<Recording Medium Conveying Device>

In the direct drawing type ink jet recording apparatus of the exemplary embodiment, a recording medium conveying device 207 is not particularly limited, and a conveying unit in a known direct drawing type ink jet recording device can be used. As an example, as shown in FIG. 3, there is a recording medium conveying device having a recording medium feeding roller 207a, a recording medium winding roller 207b, and a recording medium conveying roller 207c. According to the exemplary disclosure, it is possible to provide a porous body capable of sufficiently removing a liquid component from an ink image and suppressing image defects while improving adhesion between the layers of the porous body having a plurality of porous layers. Moreover, an ink jet recording method using the porous body can be provided.

### EXAMPLES

Hereinafter, the present disclosure will be more specifically described with reference to examples and comparative examples. The present disclosure is not limited by the following examples without departing from the gist thereof.

### Example 1

First, a method of producing a porous body formed of a fiber will be described. FIG. 1 is a schematic diagram illustrating a schematic configuration of an electrospinning apparatus according to an embodiment of the present disclosure.

As a material for forming the third layer, a 25.0% by mass dimethylacetamide/tetrahydrofuran (mass ratio 5/5) solution of polysulfone (PSU) was prepared and set in the resin solution supply device 1. A nozzle 2 formed of stainless steel having an inner diameter of 0.22 mm was used. Moreover, a collector formed of aluminum was used as the collector 4, and a distance between the nozzle 2 and the collector 4 was 15 cm.

Next, a voltage was applied in a range of 20 to 30 kV from the voltage applying device 5 to start spinning. The amount of the resin solution 3 to be supplied at this time was 1 ml/h.

The porous film thus obtained was peeled off from the collector 4 to obtain a third layer having a fiber diameter of 1.5 μm and a thickness of 50.0 μm.

The third layer obtained above was heat-treated with a hot air dryer at 120° C.

Next, the third layer after the heat treatment was attached again on the collector, and as the material forming the third layer, a dimethylacetamide/methyl isobutyl ketone (MIBK) (mass ratio 5/5) solution containing 20.0% by mass of a fluororesin (THV211GZ, manufactured by 3M Company) was prepared. To this solution, 4.0% by mass of TB2202 (manufactured by Three Bond Co., Ltd.), which is an epoxy adhesive as a thermosetting type adhesive, based on the content of the fluororesin, was further added and thus a transparent resin solution 3 in which both the fluororesin and the adhesive were dissolved was obtained. The solution was set in the resin solution supply device 1. A nozzle 2 formed of stainless steel having an inner diameter of 0.22 mm was used. The distance between the nozzle 2 and the collector 4 was 15 cm.

Next, a voltage was applied in a range of 20 to 25 kV from the voltage applying device 5 to start spinning and thus a second layer was formed on the third layer. At this time, the amount of the resin solution 3 to be supplied was 1 ml/h, and the supply time of the resin solution 3 was adjusted so that the thickness of the second layer was 1.0 μm.

Subsequently, as the material for forming the first layer, a dimethylacetamide/MIBK (mass ratio 5/5) solution containing 20% by mass of a fluororesin (THV211GZ, manufactured by 3M Company) was prepared and continuously spun onto the second layer to form a first layer on the second layer. The spinning conditions at that time were the same as those for the second layer. The amount of the resin solution 3 to be supplied at this time was 1 ml/h, and the supply time of the resin solution 3 was adjusted so that the thickness of the first layer was 15.0 μm.

The laminate having the first layer, the second layer, and the third layer obtained above was subjected to a heating and pressurizing treatment using a laboratory press T15 (manufactured by Toyo Seiki Seisakusho Co., Ltd.) under the conditions that the heating temperature was 60° C., the pressure was 3 kg/cm′, and the heating and pressing time was 3 minutes to obtain a porous body.

(Measurement of Tensile Strength)

In order to confirm the adhesive strength of each layer of the obtained porous body, the tensile strength of the porous body was measured using a fixability simulator (FSR-1000: manufactured by Rhesca Co., Ltd.). The results are shown in Table 2.

(Evaluation of Liquid Absorbency)

Further, the following evaluation was carried out and the liquid absorbency was compared.

(1) The obtained porous body is immersed in a 5% aqueous ethanol solution, and moisture is removed by air blowing.

(2) An ink applying unit uses an ink jet head that discharges an ink by an on-demand method using an electro-thermal conversion element, and the amount of the ink applied is 20 g/m². Gloria Pure White paper (product name, manufactured by Gojo Paper MFG. CO. Ltd, basis weight of 210 g/m²) was used as a recording medium.

(3) The porous body is brought into contact with an ink image on the paper surface to remove a liquid component from the ink image.

(4) The liquid component contained in the porous body is removed by air blow.

(5) The above operations (2) to (4) are repeated 100 times.

The amount of movement of the coloring material at the end portion of the image after removing the liquid component under the conditions described above is shown, and as the amount of movement becomes smaller, the image quality becomes higher and more preferable. The evaluation standards are as follows. The results are shown in Table 2.

A: There was not image deletion even in repeated use.

B: Although there was slight image deletion, the image deletion was at an ignorable level.

C: Image deletion was significantly observed.

### Example 2

As the material for forming the second layer, a dimethylacetamide/MIBK (mass ratio 5/5) solution containing 20.0% by mass of a fluororesin (THV211GZ, manufactured by 3M Company) was prepared. To this solution, 4.0% by mass of EW2070 (manufactured by 3M Company), which is an epoxy adhesive as a thermosetting type adhesive, based on the content of the fluororesin, was further added, and a transparent resin solution 3 in which the both the fluororesin and the adhesive were dissolved was obtained. A porous body was prepared in the same manner as in Example 1 except that this resin solution 3 was used and the press conditions in the heating and pressurizing treatment for the laminate after spinning were changed as shown in Table 2.

### Example 3

As the material for forming the second layer, a dimethylacetamide/MIBK (mass ratio 5/5) solution containing 20.0% by mass of a fluororesin (THV211GZ, manufactured by 3M Company) was prepared. To this solution, 31.0% by mass of TB2202 (manufactured by Three Bond Co., Ltd.), which is an epoxy adhesive as a thermosetting type adhesive, based on the content of the fluororesin, was further added, and a transparent resin solution 3 in which the both the fluororesin and the adhesive were dissolved was obtained. A porous body was prepared in the same manner as in Example 1 except that this resin solution 3 was used and the second layer was spun so as to have a thickness of 2.0 μm.

### Example 4

As the material for forming the second layer, a dimethylacetamide/MIBK (mass ratio 5/5) solution containing 20.0% by mass of a fluororesin THV211GZ, manufactured by 3M Company) was prepared. To this solution, 8.0% by mass of AP0021AW (manufactured by Toagosei Co., Ltd.), which is an epoxy adhesive as a thermosetting type adhesive, based on the content of the fluororesin, was further added, and a transparent resin solution 3 in which the both the fluororesin and the adhesive were dissolved was obtained. A porous body was prepared in the same manner as in Example 1 except that this resin solution 3 was used and the second layer was spun so as to have a thickness of 1.0 μm.

### Example 5

A porous body was prepared in the same manner as in Example 1 except that the second layer was spun so as to have a thickness of 51.0 μm.

### Comparative Example 1

A porous body was prepared in the same manner as in Example 1 except that the second layer was not formed on the third layer and the first layer was directly provided. Since there was no second layer, the adhesive force between the first porous layer and the second porous layer and the second porous layer and the third porous layer of the porous body formed under the same conditions as in Example 1 was weak and the tensile strength of the porous body was lowered.

### Comparative Example 2

A porous body was prepared in the same manner as in Example 1 except that polysulfone was used as the material forming the first layer, polyacrylonitrile (PAN) was used as the material forming the third layer, and the press conditions were changed as shown in Table 2. However, since the first layer was not formed of a fluororesin, resin particles, solid particles of a pigment and the like in the ink image adhered to the surface of the first porous layer when the porous body was brought into contact with the ink image to cause disorder of the ink image. Thus, a good image could not be obtained.

### Comparative Example 3

A porous body was prepared in the same manner as in Example 1 except that PVDF was used as the material for forming the first layer, a fluororesin (THV211GZ, manufactured by 3M Company) was used as the material for forming the third layer, and the heating temperature in the heating and pressurizing treatment was 80° C. As a result, the adhesive force between the second layer and the third layer was weak, and the tensile strength of the porous body was lowered. Since the surface energy of the third layer was low, the liquid absorbency also decreased.

Hereinafter, the configurations of the first layer, the second layer, and the third layer used for forming the porous body in Examples 1 to 5 and Comparative Examples 1 to 3, the press conditions and the obtained evaluation results are shown in Tables 1 and 2.

TABLE 1

| | | | | Second layer | | |
|---|---|---|---|---|---|---|
| | First layer | | | | | Curing reaction |
| | | Softening point | Surface energy | | Kind of | start temperature |
| | Kind of | of resin | of resin | Kind of | thermosetting | of adhesive |
| | resin | (° C.) | (mJ/m²) | resin | type adhesive | (° C.) |
| Example 1 | THV211GZ | 84 | 22 | THV211GZ | TB2202 | 60 |
| Example 2 | THV211GZ | 84 | 22 | THV211GZ | EW2070 | 85 |
| Example 3 | THV211GZ | 84 | 22 | THV211GZ | TB2202 | 60 |
| Example 4 | THV211GZ | 84 | 22 | THV211GZ | AP0021AW | 60 |
| Example 5 | THV211GZ | 84 | 22 | THV211GZ | TB2202 | 60 |
| Comparative | THV211GZ | 84 | 22 | — | — | — |
| Example 1 | | | | | | |
| Comparative | PSU | 121 | 45 | THV211GZ | TB2202 | 60 |
| Example 2 | | | | | | |
| Comparative | PVDF | 90 | 27 | THV211GZ | TB2202 | 60 |
| Example 3 | | | | | | |

| | Second layer | | Third layer | | |
|---|---|---|---|---|---|
| | Concentration | Thickness | | Softening point | Surface energy |
| | of resin | of second | Kind of | of resin | of resin |
| | (% by mass) | layer (μm) | resin | (° C.) | (mJ/m²) |
| Example 1 | 4.0 | 1.0 | PSU | 175 | 45 |
| Example 2 | 4.0 | 1.0 | PSU | 175 | 45 |
| Example 3 | 31.0 | 2.0 | PSU | 175 | 45 |
| Example 4 | 8.0 | 1.0 | PSU | 175 | 45 |
| Example 5 | 4.0 | 51.0 | PSU | 175 | 45 |
| Comparative | — | — | PSU | 175 | 45 |
| Example 1 | | | | | |
| Comparative | 1.0 | 1.0 | PAN | 130 | 60 |
| Example 2 | | | | | |
| Comparative | 1.0 | 1.0 | THV211GZ | 84 | 22 |
| Example 3 | | | | | |

TABLE 2

| | Press conditions | | |
|---|---|---|---|
| | (heating temperature/ | Tensile | |
| | pressure/heating and | strength | Liquid |
| | pressurizing treatment) | (g/cm²) | Absorbency |
| Example 1 | 60° C., 3 kg/cm², 3 min | 2400 | A |
| Example 2 | 85° C., 3 kg/cm², 3 min | 1000 | A |
| Example 3 | 60° C., 3 kg/cm², 3 min | 1300 | B |
| Example 4 | 60° C., 3 kg/cm², 3 min | 2000 | A |
| Example 5 | 60° C., 3 kg/cm², 3 min | 2000 | B |
| Comparative | 60° C., 3 kg/cm², 3 min | 200 | B |
| Example 1 | | | |
| Comparative | 120° C., 3 kg/cm², 3 min | 1000 | C |
| Example 2 | | | |
| Comparative | 80° C., 3 kg/cm², 3 min | 600 | C |
| Example 3 | | | |

While the present disclosure has been described with reference to exemplary embodiments, it is to be understood that the present invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-205400, filed Oct. 31, 2018, which is hereby incorporated by reference herein in its entirety.

What is claimed is:

1. A porous body that removes at least a part of a liquid component from an ink image by contact with the ink image containing the liquid component, the ink image being formed by applying ink to an ink receiving medium, the porous body comprising, in order:
a first porous layer;
a second porous layer; and
a third porous layer,
wherein the first porous layer has a surface in contact with the ink image,
the first porous layer and the second porous layer are bonded to each other,
the second porous layer and the third porous layer are bonded to each other,
the first porous layer has a fiber constituted by a first fluororesin,
the second porous layer has a fiber constituted by a second fluororesin and a thermoset resin, and the second fluororesin is the same as the first fluororesin, and
the third porous layer has a fiber constituted by a resin having surface energy higher than that of the first fluororesin.

2. The porous body according to claim 1,
wherein the first porous layer and the second porous layer are bonded to each other by bonding the first fluororesin and the second fluororesin to each other.

3. The porous body according to claim 1,
wherein the second porous layer and the third porous layer are bonded to each other by the thermoset resin.

4. The porous body according to claim 1,
wherein a content of the thermoset resin in the second porous layer is 0.1% by mass or more to 30% by mass or less based on a total resin content in the second porous layer.

5. The porous body according to claim 1,
wherein a thickness of the second porous layer is 50 μm or less.

6. A method of producing a porous body that removes at least a part of a liquid component from an ink image by contact with the ink image containing the liquid component, the ink image being formed by applying an ink to an ink receiving medium, the method comprising:
preparing a third layer;
forming a second layer having a fiber constituted by a second fluororesin and a thermosetting type adhesive on the third layer;
forming a first layer having a fiber constituted by a first fluororesin on the second layer to obtain a laminate having the first layer, the second layer and the third layer; and
bonding the first layer and the second layer and bonding the second layer and the third layer by heating the laminate to obtain a porous body,
wherein the second fluororesin is the same as the first fluororesin, and the third layer has a fiber constituted by a resin having surface energy higher than that of the first fluororesin.

7. The method of producing a porous body according to claim 6,
wherein a curing reaction start temperature of the thermosetting type adhesive is lower than a softening point of the second fluororesin.

8. The method of producing a porous body according to claim 6,
wherein a content of the thermosetting type adhesive in the second layer is 0.1% by mass or more to 30% by mass or less based on a total resin content in the second layer.

9. The method of producing a porous body according to claim 6,
wherein the thermosetting type adhesive is soluble in an organic solvent.

10. The method of producing a porous body according to claim 6,
wherein the first fluororesin is soluble in an organic solvent.

11. An ink jet recording method comprising:
forming an ink image containing a liquid component on an ink receiving medium by applying an ink to the ink receiving medium; and
removing at least a part of the liquid component from the ink image by bringing a porous body into contact with the ink image,
wherein the porous body has a first porous layer, a second porous layer and a third porous layer in this order,
the first porous layer has a surface in contact with the ink image,
the first porous layer and the second porous layer are bonded to each other,
the second porous layer and the third porous layer are bonded to each other,
the first porous layer has a fiber constituted by a first fluororesin,
the second porous layer has a fiber constituted by a second fluororesin and a thermoset resin, and the second fluororesin is the same as the first fluororesin, and
the third porous layer has a fiber constituted by a resin having surface energy higher than that of the first fluororesin.
